(19) United States
(12) Patent Application Publication
(10) Pub. No.: US 2024/0037286 A1
(43) Pub. Date: Feb. 1, 2024

(54) METHODS AND SYSTEMS OF GENERATING GEOMETRIC DESIGNS BASED ON SYSTEM-LEVEL DESIGNS

(71) Applicant: Palo Alto Research Center Incorporated, Palo Alto, CA (US)

(72) Inventors: Randi Wang, Mountain View, CA (US); John Turner Maxwell, III, Santa Clara, CA (US); Clinton Morris, San Carlos, CA (US); Morad Behandish, San Mateo, CA (US)

(21) Appl. No.: 17/815,998

(22) Filed: Jul. 29, 2022

(51) Int. Cl. G06F 30/12; G06F 30/20

(52) U.S. Cl. CPC G06F 30/12; G06F 30/20; G06F 2119/14

(57) ABSTRACT

This disclosure provides techniques for providing or facilitating automatic generation or conversion to geometric designs based on system-level designs. An example method may include receiving a system model from a system modeling environment. The system model describes, represents, or reflects a typology of two or more system components. The topology describes connectivity and performance by the two or more system components. A processing device extracts the topology of the two or more system components from the system model. The topology is represented by two or more connected nodes. The topology describes connectivity and performance by two or more system components. The processing device generates design spaces for the two or more connected nodes. The processing device further generates geometric representations in the design spaces for each of the two or more connected nodes to form the geometric assembly based on the system model.

### TECHNICAL FIELD

Implementations of the present disclosure relate to generating shapes or geometries.

### BACKGROUND

In product, device, or system design and development, system-level design may refer to the architecture and the composition of sub-systems or assemblies of parts. In other words, the system-level design may be represented with a collection of functional, interactive components without concerning or defining how each component is implemented (e.g., what shape or materials it may be). Therefore, the system-level design may focus on functional aspects and seek to identify requirements for each component. In a computer aided environment for system-level designs, such as Dymola, a user may provide system-level elements for simulations in the abstract. Dymola is a modeling and simulation computational environment based on the open Modelica modeling language, which is an object-oriented, declarative, and multi-domain modeling computer language.

Conventionally, once a system-level design is completed, such as when the components and functional requirements have been fully defined, users (e.g., engineers) may separately design corresponding geometry-level parts to realize those system-level elements. The parts design may focus on ascertaining shapes and dimensions of the parts to carry out the desired performance specifications of the system-level design. Computer aided design (CAD) software is a design tool that aids a user to draw, input parameters, visualize, and produce production instructions efficiently. Creating CAD models or drawings needs not depend on system-level modeling (e.g., one may draw any decorative shapes). As such, there are many CAD programs, including Fusion 360, CorelCAD, Solidworks, Tinkercad, FreeCAD, Sketchup, Solidedge, Bentley, AutoCAD, etc.

Therefore, the process of system-level designs and the process of geometry-level designs are separated and independent from each other. Such separation may lead to inefficient or sub-optimal designs, such as the geometry-level design phase may not be authorized to or capable in correcting issues of the system-level design phase, or the system-level design phase may not consider the limitations or advantages available in the geometry-level design phase.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 illustrates a block diagram of an automatic geometric assembly generation environment based on system-level designs, in accordance with certain aspects of the present disclosure.

FIG. 2 illustrates a block diagram of data flow in generating a geometric assembly based on system-level designs, in accordance with certain aspects of the present disclosure.

FIG. 3 illustrates an example of performing iterative solution similarity check for the automatic geometric assembly generation system of FIG. 1, in accordance with certain aspects of the present disclosure.

FIG. 4 illustrates a block diagram of data flow in joining output from a system-level computational environment and output from a geometric design computational environment, in accordance with certain aspects of the present disclosure.

FIG. 5 illustrates an example of extracting topology from a system-level hinge design of a tool, in accordance with certain aspects of the present disclosure.

FIG. 6 illustrates an example of constraining design spaces for parts for the system-level hinge of FIG. 5, in accordance with certain aspects of the present disclosure.

FIG. 7 illustrates an example of determining special interface position and connection types for the system-level hinge of FIGS. 5 and 6, in accordance with certain aspects of the present disclosure.

FIG. 8 illustrates an example of determining geometric representations and verifying consistency for the system-level hinge of FIGS. 5-7, in accordance with certain aspects of the present disclosure.

FIG. 9-12 illustrate flow diagrams of methods of operations by an automatic geometric assembly generation system, in accordance with certain aspects of the present disclosure.

FIG. 13 illustrates a flow diagram of methods of operations by an interfacing component in co-operation with a system-level design environment and a geometry-level design environment, in accordance with certain aspects of the present disclosure.

FIG. 14 illustrates an example computational device for performing operations of generating geometric assembly based on system-level designs, in accordance with certain aspects of the present disclosure.

Like numerals indicate like elements.

### DETAILED DESCRIPTION

The present disclosure provides various techniques for providing or facilitating automatic generation or conversion to geometric designs based on system-level designs. In current practice, system-level designs are created in a computational environment separate from a geometry-level computer aided design (CAD) environment. The system-level design often focuses on functional aspects and seeks to identify requirements for each system component, such as properties that may be realized by selection of different materials, shapes, positions, and/or movement constraints. In other words, unlike designing in a CAD environment, geometric properties may not be an essential concern in system-level designs. Because the process of system-level designs and the process of geometry-level CAD workflows are separated and independent from each other, the separation often leads to inefficient or sub-optimal designs. The present disclosure provides methods, processes, and systems for overcoming such separation, and allow users to automatically generate or realize geometry-level designs based on system-level designs.

For example, a system of the present disclosure may provide a computer design environment that allows users to input a system-level design, such as by defining functionalities and behaviors of two or more interactive system components (e.g., a spring and a damper). The computer design environment then, without further user intervention, generates (e.g., by selecting from a library and performing optimization) geometric parts that satisfy the defined functionalities and behaviors of the system-level design. In another example, a facilitating add-on software program may interface between a system-level design environment, such as Dymola, and a geometry-level CAD environment, such as Solidworks®. The add-on software program receives system-level design input from the system-level design environment, and generates (e.g., by selecting from a library) geometric designs in the geometry-level CAD environment. The add-on software program then evaluates the performance the geometric designs against the intended functionalities and behaviors of the system-level design and iteratively optimizes the geometric designs. As such, either form of implementations enables users to focus on the system-level designs and to efficiently update both the system-level designs and geometry-level designs as desired.

According to aspects of the present disclosure, an example method may include receiving user input that specifies a system model (i.e., system-level model, used interchangeably herein). The system model describes, represents, or reflects a topology of two or more system components. The topology describes connectivity and performance by the two or more system components. A processing device extracts the topology of the two or more system components from the system model. The topology is represented by two or more connected nodes. The topology describes connectivity and performance by two or more system components. The processing device generates design spaces for the two or more connected nodes. The processing device further generates geometric representations in the design spaces for each of the two or more connected nodes to form the geometric assembly based on the system model.

According to aspects of the present disclosure, an example method may include receiving a system model from a system modeling environment. The system model describes, represents, or reflects a topology of two or more system components. The topology describes connectivity and performance by the two or more system components. A processing device extracts the topology of the two or more system components from the system model. The topology is represented by two or more connected nodes (e.g., computed by the processing device). The processing device may receive (initial or reference) geometric representations for the two or more connected nodes (e.g., from a geometry-level CAD environment).

The processing device then determines, such as by performing simulations (e.g., finite element analysis, computational fluid or thermal dynamics, etc.), whether the received geometric representations match the connectivity and the performance of the topology of the system model. Upon determining that the received geometric representations do not match the connectivity and the performance of the topology of the system model, the processing device modifies at least one of the geometric representations to reduce differences between a connectivity or performance of the received and modified geometric representations and the connectivity and the performance of the topology of the system model. Details of various aspects of the present disclosure are discussed below in view of the example figures.

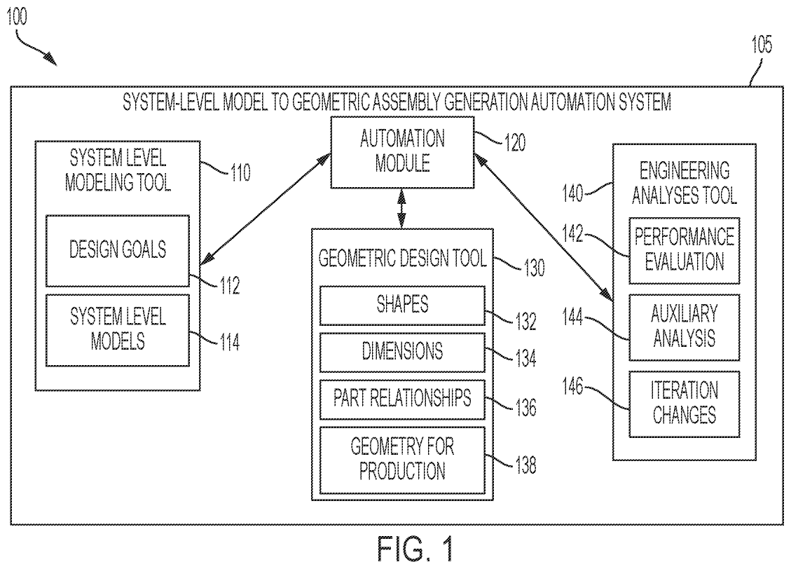

FIG. 1 illustrates a block diagram of an automatic geometric assembly generation environment or system 100 based on system-level designs, in accordance with certain aspects of the present disclosure. The geometric assembly generation system 100 may include a computational device or system 105 for system-level model to geometric assembly generation automation. The system 105 includes tools and modules (e.g., physical discrete computational devices and/or virtual machines) for providing or facilitating automatic generation or conversion to geometric designs based on system-level designs. As shown, the system 105 includes a system level modeling tool 110, an automation module 120, a geometric design tool 130, and an engineering analyses tool 140.

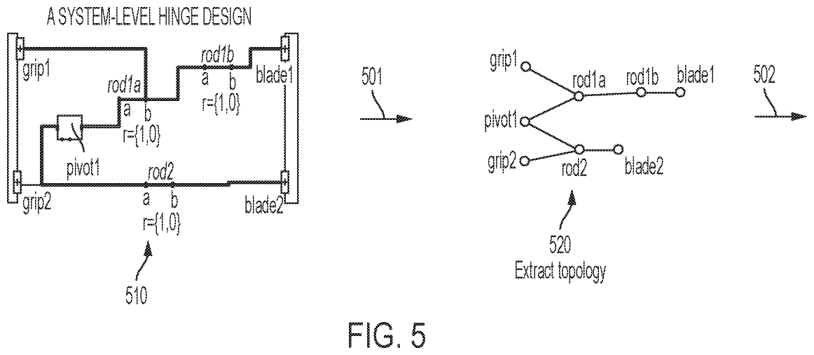

In the system level modeling tool 110, a user may define one or more design goals 112, such as stiffness, deformation, kinematics, or other functional or behavioral objectives in the system level modeling tool 110. The user may design and create system level models 114 in the system level modeling tool 110. For example, the system level models 114 may include a block diagram including multiple system components functionally connected to each other, such as a movement of one system component causing another movement of another system component. In some cases, the system level modeling tool 110 may include information about adjacency matrices, constitutive matrix sets, initial conditions sets, output of interest sets, state-space equations, and other system level modeling information. An example of a system level design 510 is illustrated in FIG. 5. In some cases, the automation module 120 may provide input or feedback in the place of the user.

The geometric design tool 130 may receive input from the user or the automation module 120. For example, the user input, review, or edit shapes 132, dimensions 134, part relationships 136, and/or geometry 138 for production. The shapes 132 may be selected from a library of shapes 132, or may be created by using drawing tools or parametric tools in the geometric design tool 130. Drawing tools enable specification of one or more points of a geometry in the geometric design tool 130. Parametric tools enable specification of relationships between one or more points and a parameter of a geometry in the geometric design tool 130, such as specifying a sphere by providing a center point and a radius. The dimensions 134 may be changed or revised by editing one or more properties (e.g., length, location, boundary, etc.) or relationships (e.g., mating conditions, such as the part relationships 136) of the shapes 132.

The part relationships 136 specify one or more joint types between parts. For example, the part relationships 136 may indicate a pin joint, a prismatic joint, a ball joint, a turnbuckle, a knuckle joint, or other joint types (e.g., fixation by adhesives). The part relationships 136 may include relative or absolute constraints of various degrees of freedoms.

The geometric design tool 130 may receive iterative updates from the automation module 120 (e.g., associated with the engineering analyses tool 140) or the user. The updates are to reduce the differences between the performance of (e.g., by simulations) of the parts designed in the geometric design tool 130 and the desired performance represented in the system level models 114 in the system level modeling tool 110. Upon convergence or optimization, a final geometry may be settled as the geometry 138 and used for production.

The engineering analyses tool 140 may include a performance evaluation module 142, an auxiliary analysis module 144, and a module 146 for recording and/or initiating iteration changes. In some cases, the engineering analyses tool 140 includes computer software to perform engineering analyses such as finite element analysis (FEA), computational fluid dynamics (CFD), multibody dynamics (MBD), durability simulations, and/or topology optimizations. For example, the performance evaluation module 142 may perform FEA based on the geometry-level designs in the geometric design tool 130. The automation module 120 may compare the FEA results in the performance evaluation module 142 with the desired performance specified in the system level modeling tool 110. When the difference exceeds a threshold, the automation module 120 may notify or provide feedback to the engineering analyses tool 140. The auxiliary analysis module 144 may identify aspects, such as parameters or changes that may be made to the geometric-level design, to update the performance simulation. The iteration changes module 146 coordinates the operations of the performance evaluation module 142, the auxiliary analysis module 144 with the automation module 120, the system level modeling tool 110, and the geometric design tool 130.

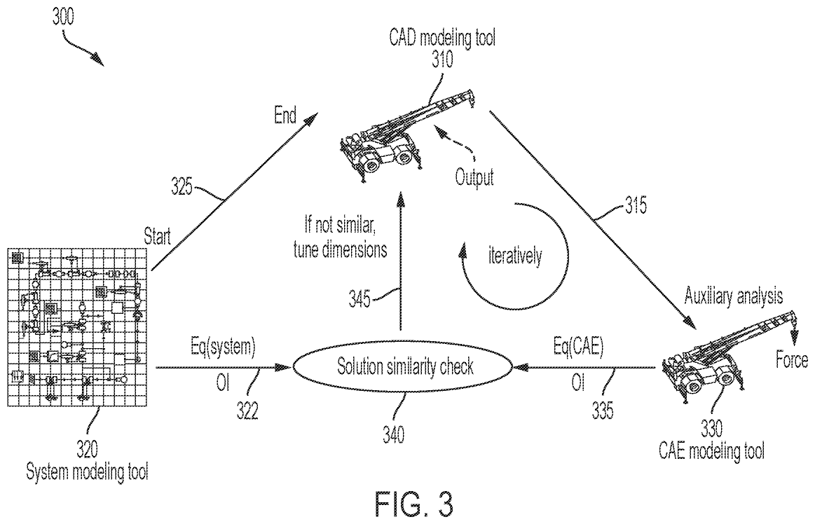

An example of workflow 300 for the system-level model to geometric assembly generation automation system 105 is illustrated in FIG. 3. As shown, the workflow 300 may start at the system modeling tool 320 (similar to the system level modeling tool 110 of the system 105), in which a user provides a system level design. At operation 325, the automation module 120 generates (e.g., by selecting in a geometry library and/or performing topology optimization) a geometric design in the CAD modeling tool 310. At operation 315, the geometric design in the CAD modeling tool 310 is analyzed in the computer aided engineering (CAE) modeling tool 330 (e.g., by applying loading conditions and simulating performance of the geometric design).

In addition to outputting the system level design to the CAD modeling tool 310, the system modeling tool 320 also provides the system level design to the automation module 120 for performing the solution similarity check 340, which is based on the design goals represented by the system equations 322 and the simulation output 335 of the CAE modeling tool 330. At 345, the automation module 120 determines that the difference between the simulation output 335 and the system equations 322 exceeds a threshold value and tunes one or more dimensions of the geometric design (e.g., updating to a new geometric design) in the CAD modeling tool 310. As such, the automation module 120 may iteratively update the geometric design in the loop formed by operations 315 and 345 until the difference between the simulation output 335 and the system equations 322 is within the threshold.

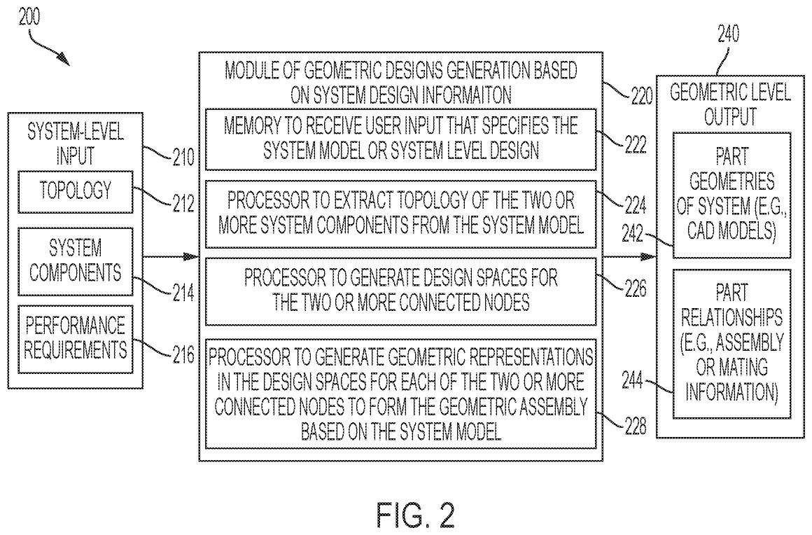

FIG. 2 illustrates a block diagram 200 of data flow in generating a geometric assembly based on system-level designs, in accordance with certain aspects of the present disclosure. As shown, the system-level input 210 is provided to a module 220 of geometric designs generation based on system design information. The module 220 generates the geometric level output 240. The system-level input 210 may include at least topology 212, system components 214, and performance requirements 216 applicable to the system-level model during operations. The performance requirements 216 may include various boundary and initial conditionals for the system-level model.

The module 220 of geometric designs generation based on system design information includes the memory 222 to receive user input that specifies the system model or system-level design from the system-level input 210. For example, the system model may include two or more system components 214 functionally interacting with each other. The system model is to be functionally realized by a geometric assembly to be automatically generated by the module 220. The system model may describe a topology of the two or more system components 214 implicitly or explicitly. The topology may describe connectivity (e.g., how system components are related to each other) and performance by the two or more system components 214. In some cases, the system model may be represented by the topology 212 in the system-level input 210. In some cases, implicit topology may be extracted from the system components 214, as discussed below.

The module 220 may include a processor 224 to process or extract the topology 212 of the two or more system components 214 from the system model. The processed or extracted topology may be represented by two or more connected nodes. The connected nodes may represent parts of the geometric level designs (e.g., representing centers of gravity, position in space, etc.). The module 220 further includes a processor 226 to generate, based on the extracted topology 212 and one or more performance requirements 216, design spaces for the two or more connected nodes. The design spaces allow the module 220 to automatically generate geometric models that may satisfy the performance requirements 216.

The module 220 may include a processor 228 to generate, iteratively, geometric representations in the design spaces for each of the two or more connected nodes to form the geometric assembly based on the received system model.

In some cases, the module 220 of geometric designs generation based on system design information may obtain material properties and manufacturing parameters associated with an additive manufacturing process of the geometric representation. The module 220 of geometric designs generation based on system design information may perform topology optimization in the design spaces for the two or more connected nodes specific to particular materials and/or additive manufacturing parameters.

The geometric level output 240 may include part geometries of the geometric assembly 242 as well as part relationships 244, which include assembly and mating information about the part geometries. The part geometries of the geometric assembly 242 may include CAD models selected from a model library, when dimensions and parameters generated by the module 220 automatically. In some cases, the selected library models or shapes may then be used for performance simulation analyses (e.g., by the engineering analyses tool 140 and/or the CAE modeling tool 330). The module 220 may then iteratively update the dimension and parameters for optimization or meeting the performance requirements 216. Herein, shapes, geometries, and geometric representations may be interchangeable. The geometry may be defined by a density model (each coordinate having a value between 0 and 1), a point cloud model (vertices each having a coordinate), a parametric model (a shape defined by one or more parameters), or a combination thereof. The geometric assembly of the part geometries are capable of performing functions of the system model.

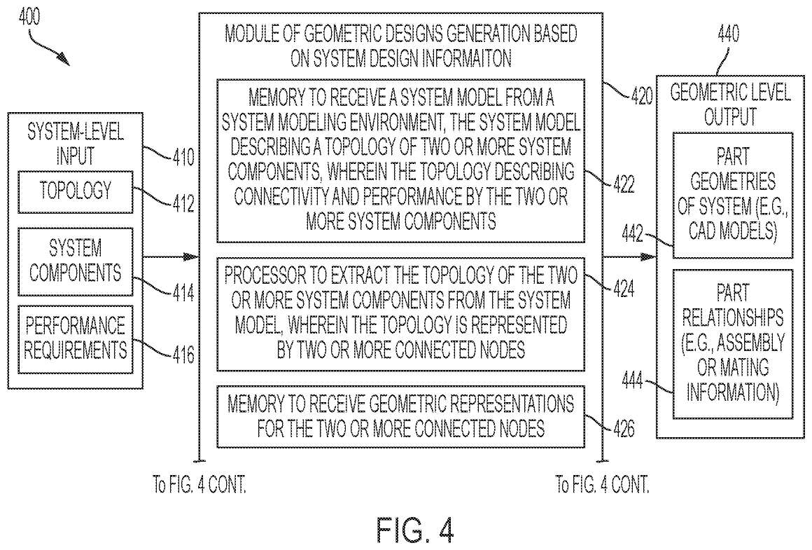

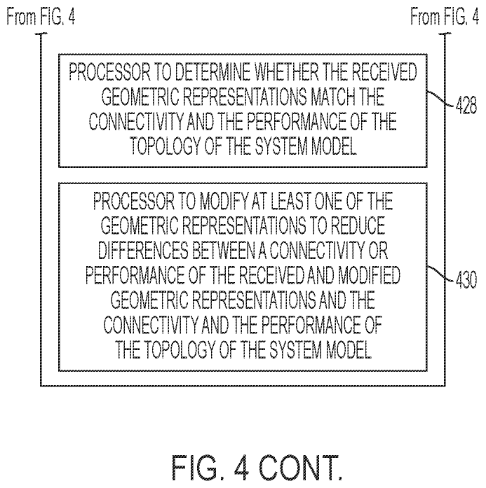

FIG. 4 illustrates a block diagram 400 of data flow in joining output from a system-level computational environment and output from a geometric design computational environment, in accordance with certain aspects of the present disclosure. Similar to the module 220 of FIG. 2, the module 420 of geometric designs generation based on system design information receives system-level input 410 and computes a geometric level output 440. The geometric level output 440 may include part geometries of the geometric assembly 442 as well as part relationships 444.

Unlike the module 220 that operates in an environment including both system-level design tools and geometry-level design tools, the module 420 may be an individual, separate, or standalone add-on or interface and operate as an extension for other third-party system-level tools and/or geometric-level tools. For example, the module 420 may be deployed to different system-level design tools that provide the system-level input 410 as well as different CAD software for the geometric level output 440 while providing automatic generation of geometric assemblies in the different CAD software.

The module 420 may include a memory 422 to receive a system model from a system modeling environment, such as Dymola. The system model may describe a topology 412 of two or more system components 414. The topology 412 may describe connectivity and performance by the two or more system components 414. The expected performance of the two or more system components 414 of the system model may be specified by the performance requirements 416 of the system-level input 410.

The module 420 includes a processor 424 to extract or process the topology of the two or more system components from the system model. The topology may be represented by two or more connected nodes generated by the module 420 or provided in the system-level input 410. Extracting the topology may include processing or converting the topology 412 (e.g., explicit topology of the system model) to a desired topology format. In some cases, extracting the topology may include processing the system components 414 to identify implicit topology for the automatic geometric assembly generation.

The module 420 may include a memory 426 to receive geometric representations for the two or more connected nodes. For example, an associated CAD software or geometric modeling tool may provide a set of initial geometric models for the module 420 to evaluate and update. In some cases, the module 420 may be a plug-in function of the associated CAD software and make use of an existing geometry library therein to obtain the initial geometric representations.

The module 420 may further include a processor 428 to determine whether the received geometric representations match the connectivity and the performance of the topology of the system model. For example, the processor 428 may perform the solution similarity check 340 of FIG. 3 or the performance evaluation 142 and/or the auxiliary analysis 144 of the engineering analyses tool 140 of FIG. 1. When the difference exceeds a threshold value, the module 420 may use the processor 430 to modify at least one of the geometric representations to reduce differences between a connectivity or performance of the received and modified geometric representations and the connectivity and the performance of the topology of the system model. For example, the processor 430 may, based on the performance requirement 416, change at least one of the system-level design or the geometry-level design to realize the required performance.

In some cases, the system-level computational environment and/or the geometric design computational environment in the block diagram 400 may be remote to the module 420 and connected via local or global networks. For example, the module 420 may include client interfaces in either or both of the system-level computational environment and the geometric design computational environment. The module 420 may serve different clients with different system-level model inputs, such as by providing an online service. In some cases, the module 420 is installed locally to avoid potential data transmission interruption.

FIG. 5 illustrates an example of extracting topology from a system-level hinge design of a tool, in accordance with certain aspects of the present disclosure. As shown, a system-level model 510 of a hinge design is provided to a processing device such as the automation module 120 of FIG. 1, the module 220 of FIG. 2, or the module 420 of FIG. 4. The system-level hinge design 510 includes system components of a first grip, a second grip, a pivot, a first blade, and a second blade for a set of pliers, clamps, or scissors. In this example, the first grip connects to the first blade by rod1b. The second grip connects to the second blade by rod1a, pivot1, and rod2. And the pivot1 connects rod1a and rod2. The system-level model 510 is extracted into a topology 520 via the operation 501.

The operation 501 may include one or more of: determining positional information of each of the two or more system components; determining connectivity relationships among the two or more system components; identifying centers of gravity of the two or more system components; constraining the design spaces for the geometric representations; and determining spatial interface positions of the geometric representations.

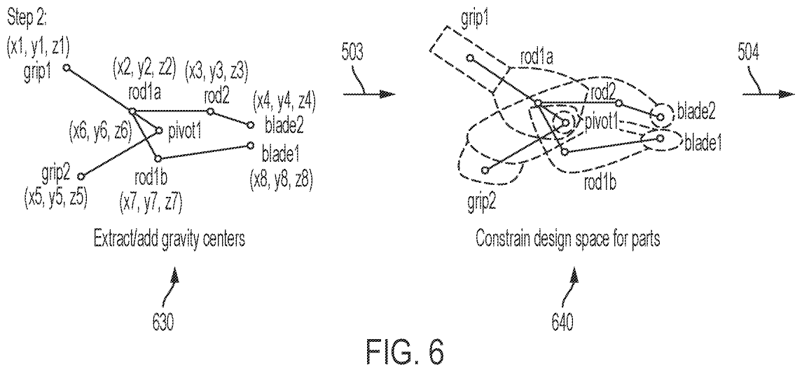

As shown, the extracted topology 520 may include multiple connected nodes representing the first grip, the second grip, the pivot, the first blade, the second blade, and multiple connection rods without geometric information. The topology 520 is further processed at operation 502 for obtaining or designating centers of gravities for each node, as shown in FIG. 6.

FIG. 6 illustrates an example of constraining design spaces for parts for the system-level hinge of FIG. 5. As shown, the topology 520 is processed and updated into topology 630 with positions of centers of gravity for each node. Based on the centers of gravity, the processing device in operation 503 further constrains or determines a design space for each node of the updated topology 630. The processing device may select and modify a part geometry in each of the design spaces 640. The processing device in operation 504 decides spatial interface positions 730 for the nodes. As shown, some nodes are to move as a group during operations. The movement under loading conditions may be determined by the joint types, stiffness, movement freedom of the components, and other constraints.

The processing device may, in operation 505, determine connection types 740 and/or occupied spaces of the nodes. For example, the processing device may select applicable connection types 740 from a database or library. The connection types 740 may be one of kinematic joints (e.g., moveable joints, such as revolute joints) or none-kinematic joints (e.g., fixed joints, such as by adhesion).

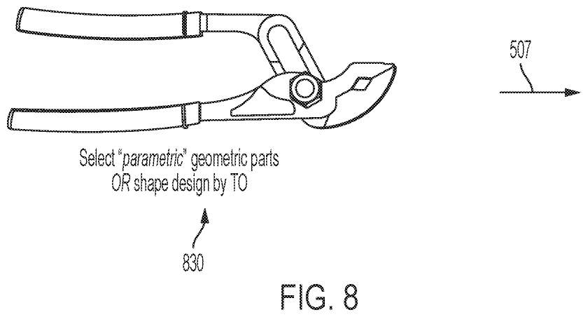

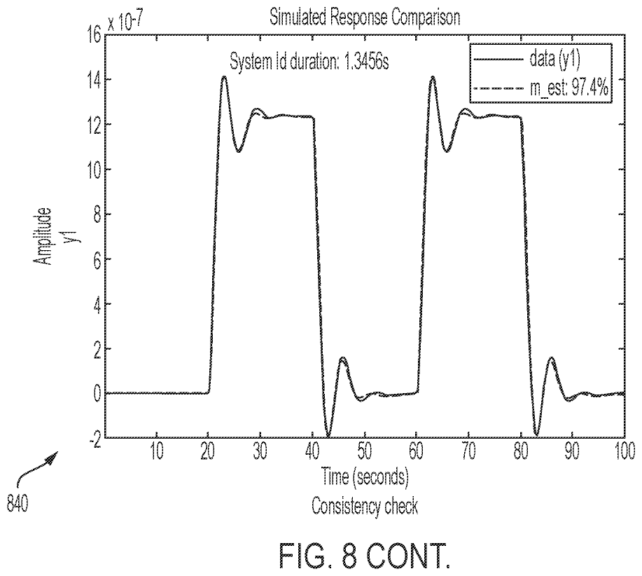

The processing device may, in operation 506, select parametric geometric parts that satisfy the connection types 740 and/or perform topology optimization to generate a geometric assembly 830 as shown in FIG. 8. Parametric geometric parts include parts that use variables for geometry definition. For example, radius, thickness, locations of geometric features, and other parameters may be defined and updated to generate a geometric part. The library of the geometric parts may therefore include parametric models to be further defined by parameters, such as dimensions, tolerance, aspect ratios, feature distribution/locations, etc. In some cases, the geometric assembly 830 may be represented with initial geometries of basic shapes. The processing device may further revise or refine the basic shapes via topology optimization or other optimization processes.

The processing device may, in operation 507, perform engineering analysis to compare the performance of the geometric assembly 830 and the intended performance of the system model 510. As shown in FIG. 8, a plot 840 provides results of an example consistency check. The plot 840 shows that the simulated response of the geometric assembly 830 is similar to (e.g., 97.4% consistent) the expected performance of the system model 510. A user may define a threshold of the consistency check. If the difference exceeds the threshold, the processing device may iteratively update the geometric assembly 830 until the difference becomes within the threshold.

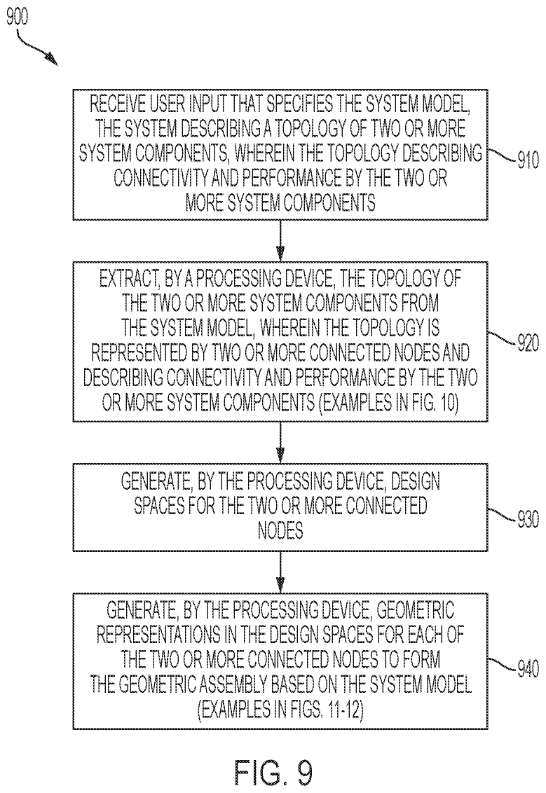

FIG. 9-12 illustrate flow diagrams of methods of operations by an automatic geometric assembly generation system, in accordance with certain aspects of the present disclosure. For example, the operations may correspond to the processes described with reference to the geometric assembly generation example in FIGS. 5-8. The operations may be performed by a processing device, such as the automation module 120 as described with reference to FIG. 1.

Turning first to FIG. 9, the operation 900 begins at 910 by receiving user input that specifies a system model. The operation 900 is to generate a geometric assembly based on the system model, which describes a topology of two or more system components.

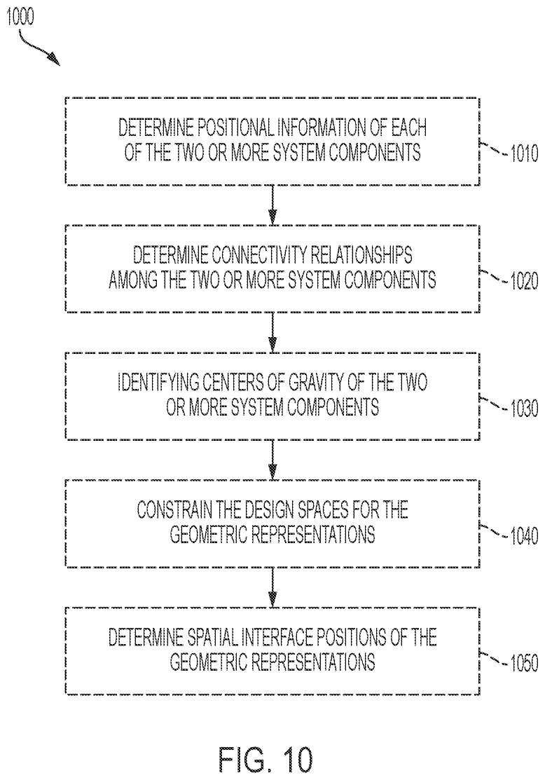

At 920, a processing device extracts or processes the topology of the two or more system components from the system model. The topology is represented by two or more connected nodes and describing connectivity and performance by the two or more system components. In some cases, the two or more connected nodes are generated by the processing device based on implicit description of the topology in the system model. In some cases, the two or more nodes are indicated in an explicit topology, depending on specific format of the system model. Example operations for extracting the topology of the two or more system components are illustrated in FIG. 10.

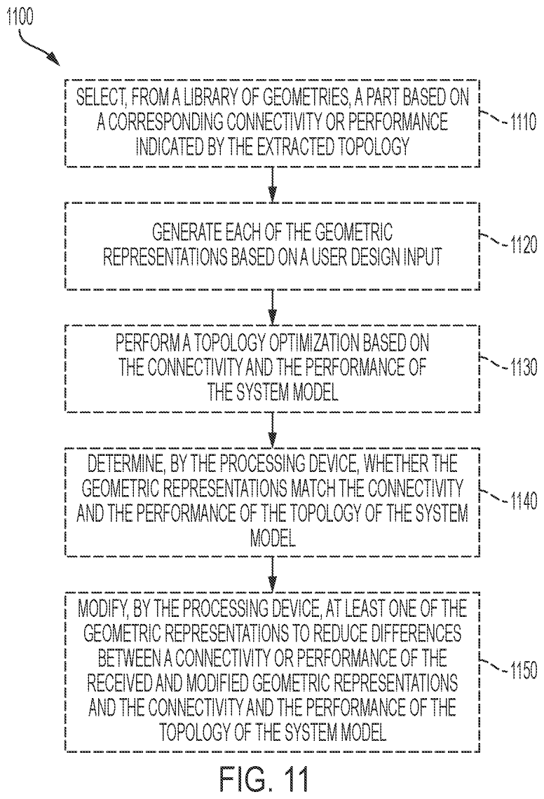

At 930, the processing device generates design spaces for the two or more connected nodes. For example, the processing device may identify boundary limits and/or movements of each of the two or more nodes to determine design spaces for the two or more connected nodes. Example operations for generating the design spaces are illustrated in FIG. 11.

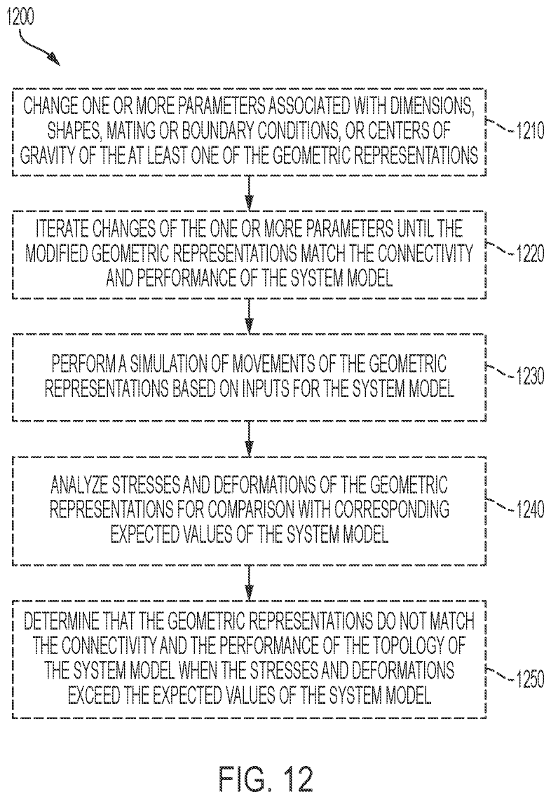

At 940, the processing device generates geometric representations in the design spaces for each of the two or more connected nodes to form the geometric assembly based on the system model. Example operations for generating geometric representations in the design spaces are illustrated in FIG. 12.

Turning now to FIG. 10, the processing device may extract the topology of the two or more system components from the system model by performing one or more of the following operations 1000. At 1010, the processing device may determine positional information of each of the two or more system components. For example, positions of the system components relative to each other and relative to the overall system are ascertained based on the system model.

At 1020, the processing device may determine connectivity relationships among the two or more system components. The connectivity relationships may correspond to or represent mating conditions of the two or more system components.

At 1030, the processing device may identify centers of gravity of the two or more system components. The center of gravity of each system component may be represented by a coordinate according to the requirements of the system model, as shown in the updated topology 630 of FIG. 6.

At 1040, the processing device may constrain the design spaces for the geometric representations, as illustrated in the example design space constraints 640 of FIG. 6.

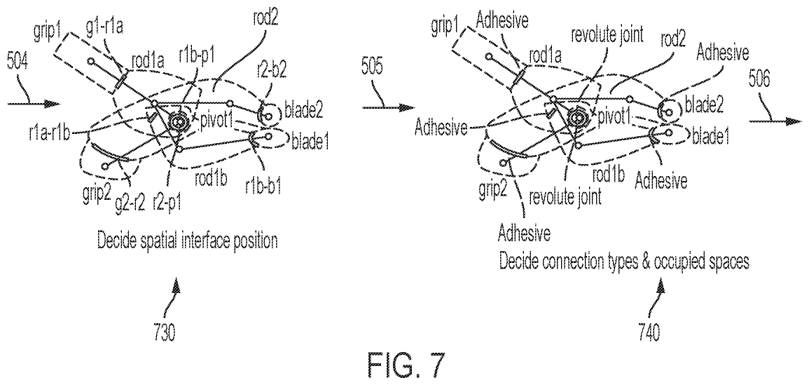

At 1050, the processing device may determine spatial interface positions of the geometric representations, as shown in the example spatial interface positions 730 of FIG. 7.

Turning now to FIG. 11, the processing device may generate the geometric representations in the design spaces for each of the two or more connected nodes to form the geometric assembly by performing at least one of the following operations 1100.

At 1110, the processing device may select, from a library of geometries, a part based on a corresponding connectivity or performance indicated by the extracted topology.

At 1120, the processing device may generate each of the geometric representations based on a user design input.

At 1130, the processing device may perform a topology optimization based on the connectivity and the performance of the system model.

At 1140, the processing device may determine whether the geometric representations match the connectivity and the performance of the topology of the system model. For example, CAE analyses may simulate the performance of the geometric representations and the simulation results are compared against the design goals of the system model. A user may define an acceptable threshold for the similarity check.

At 1150, upon determining that the geometric representations do not match the connectivity and the performance of the topology of the system model (e.g., differences exceed the threshold), the processing device may modify at least one of the geometric representations to reduce differences between a connectivity or performance of the received and modified geometric representations and the connectivity and the performance of the topology of the system model.

Turning now to FIG. 12, the processing device may modify the at least one of the geometric representations by performing one of the following operations 1200.

At 1210, the processing device may change one or more parameters associated with dimensions, shapes, mating or boundary conditions, or centers of gravity of the at least one of the geometric representations.

At 1220, the processing device may iterate changes of the one or more parameters until the modified geometric representations match the connectivity and performance of the system model.

At 1230, the processing device may determine whether the geometric representations match the connectivity and the performance of the topology of the system model by performing a simulation of movements (e.g., in a CAE environment) of the geometric representations based on inputs for the system model.

At 1240, the processing device may further analyze stresses and deformations of the geometric representations for comparison with corresponding expected values of the system model.

At 1250, the processing device may determine that the geometric representations do not match the connectivity and the performance of the topology of the system model when the stresses and deformations exceed the expected values of the system model. In response, the processing device may repeat operations 1210 and 1220 until the simulated performance of the updated geometric representations match the requirements in the system model.

In some cases, the geometric representations that form the geometric assembly corresponding to the system model include shapes to be produced by additive manufacturing without assembly. For example, the generated geometric parts are manufactured connected. Various additive manufacturing techniques may be used, including selective laser sintering (SLS), selective laser melting (SLM), and laser powder bed fusion (LPBF). In some cases, the processing device may update the geometric representations specific to the manufacturing techniques and/or limitations of the production parameters.

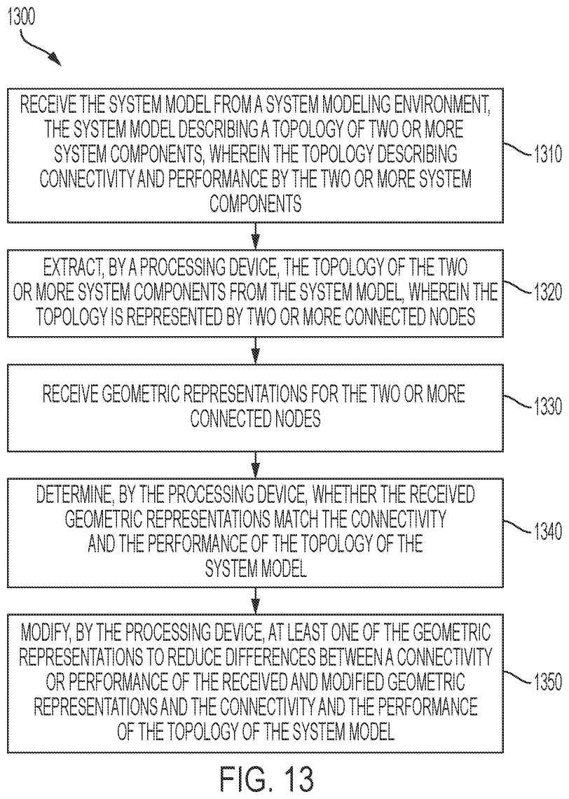

FIG. 13 illustrates a flow diagram of methods of operations 1300 by an interfacing component in co-operation with a system-level design environment and a geometry-level design environment, in accordance with certain aspects of the present disclosure. For example, the operations 1300 may correspond to the processes described with reference to the geometric assembly generation example in FIGS. 5-8. The operations 1300 may be performed by a processing device, such as the module 420 as described with reference to FIG. 4.

The operations 1300 begins, at 1310, by receiving the system model from a system modeling environment, the system model describing a topology of two or more system components. For example, the system model is provided from an external system-level modeling environment, such as Dymola. The topology describes or reflects connectivity and performance by the two or more system components.

At 1320, a processing device may extract or process the topology of the two or more system components from the system model. The topology is represented by two or more connected nodes.

At 1330, the processing device receives geometric representations for the two or more connected nodes. For example, the processing device may receive initial shapes in a library of a CAD software.

At 1340, the processing device determines whether the received geometric representations match the connectivity and the performance of the topology of the system model.

At 1350, upon determining that the received geometric representations do not match the connectivity and the performance of the topology of the system model, the processing device modifies at least one of the geometric representations to reduce differences between a connectivity or performance of the received and modified geometric representations and the connectivity and the performance of the topology of the system model.

In some cases, receiving the geometric representations may include providing, via a plug-in client interface, a geometric modeling environment (e.g., an external CAD environment) the extracted topology including positions and constraints of each of the two or more connected nodes. The processing device then receives the geometric representations from the geometric modeling environment. The geometric representations may be selected or generated by the client interface and the processing device according to the positions and constraints of the two or more connected nodes. The selection may be based on a library of models, including parametric models, in the geometric modeling environment. During operations, the processing device may communicate with the client interface to participate in the selection or generation of the geometric representations.

In some cases, each of the geometric representations is generated in the geometric modeling environment based on at least one of: a part selection from a library of geometries based on a corresponding connectivity or performance indicated by the extracted topology; a user design input; or an output of a topology optimization. In some cases, the processing device may determine whether the received geometric representations match the connectivity and the performance of the topology of the system model by performing a simulation of movements of the geometric representations based on inputs for the system model. The processing device may analyze stresses and deformations of the geometric representations for comparison with corresponding expected values of the system model. In some cases, the processing device may determine that the received geometric representations do not match the connectivity and the performance of the topology of the system model when the stresses and deformations exceed the expected values of the system model.

In some cases, the processing device may extracting the topology of the two or more system components from the system model by performing one or more of: obtaining positional information of each of the two or more system components; identifying connectivity relationships among the two or more system components; identifying centers of gravity of the two or more system components; constraining design spaces for the geometric representations; and determining spatial interface positions of the geometric representations.

In some cases, the processing device may modify the at least one of the geometric representations by changing one or more parameters associated with dimensions, shapes, mating or boundary conditions, or centers of gravity of the at least one of the geometric representations; and iterating changes of the one or more parameters until the modified geometric representations match the connectivity and performance of the system model.

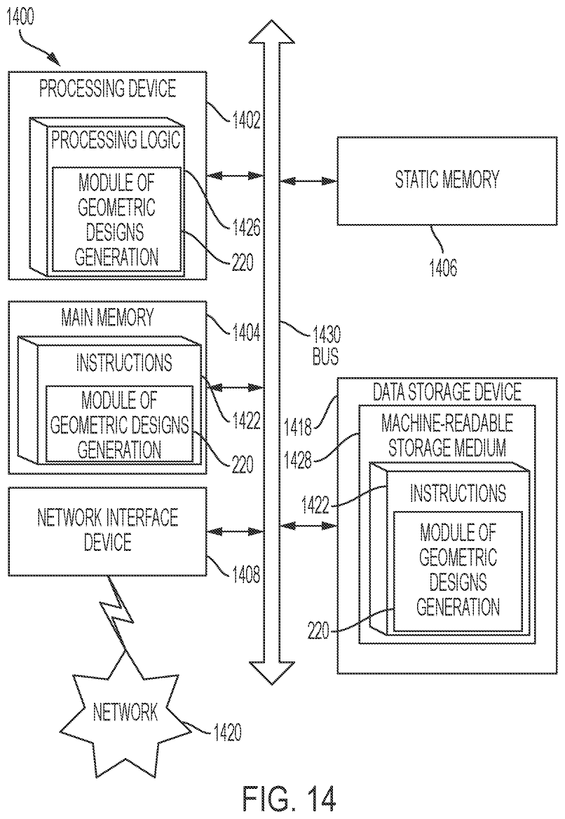

FIG. 14 illustrates a diagrammatic representation of a machine in the example form of a computer system 1400 within which a set of instructions 1422, for causing the machine to perform any one or more of the methodologies discussed herein (such as the operations 900-1300), may be executed. In various embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 1400 may be representative of a server computer system, such as system 105, the module 220, or the module 420.

The exemplary computer system 1400 includes a processing device 1402, a main memory 1404 (e.g., read-only memory (ROM), flash memory, dynamic random access memory (DRAM), a static memory 1406 (e.g., flash memory, static random access memory (SRAM), etc.), and a data storage device 1418, which communicate with each other via a bus 1430. The processing device 1402 may be implemented as the automation module 120, or a related processing device unit. In some cases, the processing device 1402 may be used to perform tasks associated with the automation module 120. Any of the signals provided over various buses described herein may be time multiplexed with other signals and provided over one or more common buses. Additionally, the inter 1429 connection between circuit components or blocks may be shown as buses or as single signal lines. Each of the buses may alternatively be one or more single signal lines and each of the single signal lines may alternatively be buses.

Processing device 1402 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 1402 may also be one or more special-purpose processing devices such as an application specific integrated circuit (ASIC), a field programmable gate array (FPGA), a digital signal processor (DSP), network processor, or the like. The processing device 1402 may execute processing logic 1426, which may be one example of system 100 shown in FIG. 1, for performing the operations and steps discussed herein, such as the operation 1000 of FIG. 10. The processing logic 1426 may include the automation module 120 of FIG. 1.

The data storage device 1418 may include a machine-readable storage medium 1428, on which is stored one or more set of instructions 1422 (e.g., software) embodying any one or more of the methodologies of functions described herein, including instructions to cause the processing device 1402 to execute the system 100. For example, the instructions 1422 may include the module 220 of geometric designs generation. The instructions 1422 may also reside, completely or at least partially, within the main memory 1404 or within the processing device 1402 during execution thereof by the computer system 1400; the main memory 1404 and the processing device 1402 also constituting machine-readable storage media. The instructions 1422 may further be transmitted or received over a network 1420 via the network interface device 1408.

The non-transitory machine-readable storage medium 1428 may also be used to store instructions to perform the methods and operations described herein. While the machine-readable storage medium 1428 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular embodiments may vary from these exemplary details and still be contemplated to be within the scope of the present disclosure.

Additionally, some embodiments may be practiced in distributed computing environments where the machine-readable medium is stored on and or executed by more than one computer system. In addition, the information transferred between computer systems may either be pulled or pushed across the communication medium connecting the computer systems.

Embodiments of the claimed subject matter include, but are not limited to, various operations described herein. These operations may be performed by hardware components, software, firmware, or a combination thereof.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

It will be appreciated that variants of the above-disclosed and other features and functions, or alternatives thereof, may be combined into may other different systems or applications. Various presently unforeseen or unanticipated alternatives, modifications, variations, or improvements therein may be subsequently made by those skilled in the art which are also intended to be encompassed by the following claims. The claims may encompass embodiments in hardware, software, or a combination thereof.

What is claimed is:

1. A method of generating a geometric assembly based on a system model, the method comprising:
receiving user input that specifies the system model, the system model describing a topology of two or more system components, wherein the topology represents connectivity and performance by the two or more system components;
extracting, by a processing device, the topology of the two or more system components from the system model, wherein the topology is represented by two or more connected nodes and describing connectivity and performance by the two or more system components;
generating, by the processing device, design spaces for the two or more connected nodes; and
generating, by the processing device, geometric representations in the design spaces for each of the two or more connected nodes to form the geometric assembly based on the system model.

2. The method of claim 1, wherein extracting the topology of the two or more system components from the system model comprises one or more of:
determining positional information of each of the two or more system components;
determining connectivity relationships among the two or more system components;
identifying centers of gravity of the two or more system components;
constraining the design spaces for the geometric representations; and
determining spatial interface positions of the geometric representations.

3. The method of claim 1, wherein generating the geometric representations in the design spaces for each of the two or more connected nodes to form the geometric assembly comprises at least one of:
selecting, from a library of geometries, a part based on a corresponding connectivity or performance indicated by the extracted topology;
generating each of the geometric representations based on a user design input; or
performing a topology optimization based on the connectivity and the performance of the system model.

4. The method of claim 3, wherein generating the geometric representations in the design spaces for each of the two or more connected nodes to form the geometric assembly further comprises:
determining, by the processing device, whether the geometric representations match the connectivity and the performance of the topology of the system model; and
upon determining that the geometric representations do not match the connectivity and the performance of the topology of the system model, modifying, by the processing device, at least one of the geometric representations to reduce differences between a connectivity or performance of the received and modified geometric representations and the connectivity and the performance of the topology of the system model.

5. The method of claim 4, wherein modifying the at least one of the geometric representations comprises:
changing one or more parameters associated with dimensions, shapes, mating or boundary conditions, or centers of gravity of the at least one of the geometric representations; and
iterating changes of the one or more parameters until the modified geometric representations match the connectivity and performance of the system model.

6. The method of claim 5, wherein determining, by the processing device, whether the geometric representations match the connectivity and the performance of the topology of the system model comprises:
performing a simulation of movements of the geometric representations based on inputs for the system model;
analyzing stresses and deformations of the geometric representations for comparison with corresponding expected values of the system model; and
determining that the geometric representations do not match the connectivity and the performance of the topology of the system model when the stresses and deformations exceed the expected values of the system model.

7. The method of claim 3, wherein the geometric representations forming the geometric assembly comprise shapes to be produced by additive manufacturing without assembly.

8. A method of generating a geometric assembly based on a system model, the method comprising:
receiving the system model from a system modeling environment, the system model describing a topology of two or more system components, wherein the topology represents connectivity and performance by the two or more system components;
extracting, by a processing device, the topology of the two or more system components from the system model, wherein the topology is represented by two or more connected nodes;
receiving geometric representations for the two or more connected nodes;
determining, by the processing device, whether the received geometric representations match the connectivity and the performance of the topology of the system model; and
upon determining that the received geometric representations do not match the connectivity and the performance of the topology of the system model, modifying, by the processing device, at least one of the geometric representations to reduce differences between a connectivity or performance of the received and modified geometric representations and the connectivity and the performance of the topology of the system model.

9. The method of claim 8, wherein receiving the geometric representations comprises:
providing a geometric modeling environment the extracted topology including positions and constraints of each of the two or more connected nodes; and
receiving the geometric representations from the geometric modeling environment, wherein the geometric representations are generated according to the positions and constraints of the two or more connected nodes.

10. The method of claim 9, wherein each of the geometric representations is generated in the geometric modeling environment based on at least one of:
a part selection from a library of geometries based on a corresponding connectivity or performance indicated by the extracted topology;
a user design input; or
an output of a topology optimization.

11. The method of claim 8, wherein determining, by the processing device, whether the received geometric representations match the connectivity and the performance of the topology of the system model comprises:
performing a simulation of movements of the geometric representations based on inputs for the system model; and
analyzing stresses and deformations of the geometric representations for comparison with corresponding expected values of the system model.

12. The method of claim 11, further comprising determining that the received geometric representations do not match the connectivity and the performance of the topology of the system model when the stresses and deformations exceed the expected values of the system model.

13. The method of claim 8, wherein extracting the topology of the two or more system components from the system model comprises one or more of:
obtaining positional information of each of the two or more system components;
identifying connectivity relationships among the two or more system components;
identifying centers of gravity of the two or more system components;
constraining design spaces for the geometric representations; and
determining spatial interface positions of the geometric representations.

14. The method of claim 8, wherein modifying the at least one of the geometric representations comprises:
changing one or more parameters associated with dimensions, shapes, mating or boundary conditions, or centers of gravity of the at least one of the geometric representations; and
iterating changes of the one or more parameters until the modified geometric representations match the connectivity and performance of the system model.

15. A system of generating a geometric assembly based on a system model, the system comprising:
a memory; and
a processing device coupled to the memory, the processing device and the memory configured to:
receive user input that specifies the system model, the system model describing a topology of two or more system components, wherein the topology represents connectivity and performance by the two or more system components;
extract, by a processing device, the topology of the two or more system components from the system model, wherein the topology is represented by two or more connected nodes and describing connectivity and performance by the two or more system components;
generate, by the processing device, design spaces for the two or more connected nodes; and
generate, by the processing device, geometric representations in the design spaces for each of the two or more connected nodes to form the geometric assembly based on the system model.

16. The system of claim 15, wherein the processing device and the memory are configured to extract the topology of the two or more system components from the system model by performing one or more of the following:
determining positional information of each of the two or more system components;
determining connectivity relationships among the two or more system components;
identifying centers of gravity of the two or more system components;
constraining the design spaces for the geometric representations; and
determining spatial interface positions of the geometric representations.

17. The system of claim 15, wherein the processing device and the memory are configured to generate the geometric representations in the design spaces for each of the two or more connected nodes to form the geometric assembly by performing at least one of:
selecting, from a library of geometries, a part based on a corresponding connectivity or performance indicated by the extracted topology;
generating each of the geometric representations based on a user design input; or
performing a topology optimization based on the connectivity and the performance of the system model.

18. The system of claim 17, wherein the processing device and the memory are configured to generate the geometric representations in the design spaces for each of the two or more connected nodes to form the geometric assembly by further performing the following:
determining, by the processing device, whether the geometric representations match the connectivity and the performance of the topology of the system model; and
upon determining that the geometric representations do not match the connectivity and the performance of the topology of the system model, modifying, by the processing device, at least one of the geometric representations to reduce differences between a connectivity or performance of the received and modified geometric representations and the connectivity and the performance of the topology of the system model.

19. The system of claim 18, wherein the processing device and the memory are configured to modify the at least one of the geometric representations by:
changing one or more parameters associated with dimensions, shapes, mating or boundary conditions, or centers of gravity of the at least one of the geometric representations; and
iterating changes of the one or more parameters until the modified geometric representations match the connectivity and performance of the system model.

20. The system of claim 19, wherein the processing device and the memory are configured to determine whether the geometric representations match the connectivity and the performance of the topology of the system model by:
performing a simulation of movements of the geometric representations based on inputs for the system model;
analyzing stresses and deformations of the geometric representations for comparison with corresponding expected values of the system model; and
determining that the geometric representations do not match the connectivity and the performance of the topology of the system model when the stresses and deformations exceed the expected values of the system model.
